(19) United States
(12) Patent Application Publication
(10) Pub. No.: US 2025/0367675 A1
(43) Pub. Date: Dec. 4, 2025

(54) SWING JAW OF A JAW CRUSHER

(71) Applicant: SANDVIK LTD, Dungannon (GB)

(72) Inventors: Stuart SMYTH, Dungannon (GB); Stuart GRAYDON, Dungannon (GB); Adam BAXTER, Dungannon (GB)

(21) Appl. No.: 18/875,930

(22) PCT Filed: Jun. 19, 2023
(86) PCT No.: PCT/EP2023/066390

§ 371 Date: Dec. 17, 2024

(30) Foreign Application Priority Data
Jun. 21, 2022 (EP) 22180049.3

(51) Int. Cl. B02C 1/10; B02C 1/04

(52) U.S. Cl. CPC B02C 1/10; B02C 1/04

(57) ABSTRACT

A swing jaw of a jaw crusher includes a cast swing jaw frame and a retention seat for a toggle seat having a first retention seat part. The retention seat includes a detachable retention plate that is configured to couple to the first retention seat part so as to clamp a toggle seat therebetween in a wedged clamping arrangement. The first retention seat part is usually integrally cast with the cast swing jaw frame. The retention seat upon assembly has opposed sidewalls that diverge towards a rear wall of the retention seat to wedge the toggle seat in position in the assembled retention seat. Generally, the first retention seat part has a first sidewall and a rear wall of the retention seat, the detachable retention plate having a second sidewall of the retention seat.

### FIELD OF THE INVENTION

The present invention relates to a swing jaw of a jaw crusher having an improved toggle plate retention seat. Also contemplated is a jaw crusher comprising the swing jaw and improved toggle plate retention seat.

### BACKGROUND TO THE INVENTION

In a jaw crusher the high crushing loads are typically transferred through a device known as a toggle plate. The toggle plate is normally held and supported on two seats (known as toggle plate seats or simply “toggle seats”). The seats allow the toggle plate to pivot and transfer the crushing load efficiently-however, as the plate hinges on these seats the seats are subject to wear. If this wear gets excessive the load transfer of the crushing forces can become unstable and the seat needs changed. Over time the large crushing forces can and do permanently deform the toggle seats-once these deform, they become mechanically stuck in place and removal becomes a very difficult task. The toggle seats are mounted to retaining seats cast into the swing jaw. They are illustrated in FIGS. 1 and 2 and show the toggle seat 2 friction fit into a recess cast into the cast retention seat 3. It has been noted that in the past that a toggle seat when it has become deformed through use needs to be cut out of the retention seat using hot tools or pulling lugs welded onto them and pulled with an external force. These practices are very much unsafe and should be avoided.

It is an objective of the invention to overcome at least one of the above-referenced problems.

### SUMMARY OF THE INVENTION

The objective is met by the provision of a swing jaw as set forth in appended claim 1. Preferred embodiments and advantages are set forth in the appended dependent claims and will become apparent from the description.

In one aspect there is provided a retention seat assembly for a toggle seat. The retention seat assembly comprises a toggle seat and a retention seat for the toggle seat. The retention seat comprises a first retention seat part cast into the swing jaw casting and a second retention seat part provided by a detachable retention plate that is detachably mounted to the first retention seat part. The first retention seat part and second retention seat part when assembled define a recessed retention seat with opposed sidewalls that diverge towards a rear of the assembled retention seat, so that in use the toggle seat is held in position in the seat in a wedged clamping arrangement. Unlike the retention seat of the prior art which is entirely cast and therefore requires cutting or welding when a toggle seat is removed, replacement of the toggle seat of the invention involves no cutting or welding but simply requires the detachable plate(s) of the retention seat to be unbolted and detached from the swing jaw casting, allowing the toggle seat to be easily detached from the swing jaw frame.

In a first aspect, the invention provides a swing jaw of a jaw crusher comprising:
a cast swing jaw frame; and
a retention seat for a toggle seat comprising a first retention seat part,
   wherein the retention seat comprises a detachable retention plate that is configured to couple to the first retention seat part so as to clamp a toggle seat therebetween in a wedged clamping arrangement.

In any embodiment, the first retention seat part is integrally cast with the cast swing jaw frame. This arrangement minimises the number of parts required to mount the toggle seat to the cast swing jaw and the retention plate(s).

In any embodiment, the retention seat upon assembly comprises opposed sidewalls, wherein a lower side wall of the opposed side walls diverges towards a rear wall of the retention seat, to wedge the toggle seat in position in the assembled retention seat.

In any embodiment, the retention seat comprises opposed sidewalls at least one of which, and ideally both of which, diverge towards a rear of the retention seat, to wedge the toggle seat in position in the assembled retention seat. This arrangement allows the toggle plate to be held in a wedged clamping arrangement.

In any embodiment, the retention seat comprises a support recess 59 extending into the retention seat 20 beyond the rear wall 22 and configured to receive a support flange 60 of the toggle seat 19 for supporting the toggle seat 19 in a suspended position.

In any embodiment, the cast toggle seat part comprises a first sidewall and rear wall of the toggle seat.

In any embodiment, the detachable retention plate comprises a second sidewall of the toggle seat.

In any embodiment, the cast swing jaw frame comprises a recess for the detachable retention plate.

In any embodiment, the detachable retention plate comprises a first part dimensioned to be accommodated in the recess and a second part that extends proud of the recess and comprises the second sidewall of the toggle seat.

In any embodiment, the swing jaw comprises a toggle seat.

In any embodiment, the toggle seat comprises a rear seat wall, a front seat wall comprising an elongated plate-receiving groove, a first seat sidewall and a second seat sidewall.

In any embodiment, the second seat sidewall is a lower seat sidewall of the first seat sidewall 48 and the second seat sidewall 50, wherein the lower second seat sidewall diverge towards the rear seat wall.

In any embodiment, the first seat sidewall and second seat sidewall diverge towards the rear seat wall. This arrangement is to allow the toggle seat to be wedged in place in the toggle plate seat when assembled. Ideally, both sidewall toggle plates diverge outwardly towards the rear plate wall.

In any embodiment, the retention plate is bolted to the cast swing jaw frame.

In any embodiment, the retention seat comprises two detachable retention plates.

In a second aspect, the invention provides a jaw crusher comprising a fixed jaw and a swing jaw according to the invention.

In a third aspect, the invention provides a toggle seat assembly for mounting a toggle plate to a swing jaw of a jaw crusher, the toggle seat assembly comprising:
a toggle seat configured to be bolted to a cast swing jaw frame, the toggle seat comprises a rear seat wall, a front seat wall comprising an elongated plate-receiving groove, a first seat sidewall and a second seat sidewall; and
a retention plate having a mounting face and an opposed front face,
wherein the mounting face of the retention plate comprises an elongated recess disposed along an edge of the mounting plate that is dimensioned to receive at least part of the first or second seat sidewall of the toggle seat.

In any embodiment, the first seat sidewall and second seat sidewall of the toggle seat diverge towards the rear seat wall.

In a fourth aspect, the invention provides a toggle seat for a toggle plate of a jaw crusher, the toggle seat comprising an elongated body comprising a rear seat wall, a front seat wall comprising an elongated plate-receiving groove, a first seat sidewall and a second seat sidewall, wherein at least a part of the first seat sidewall and second seat sidewall of the toggle seat diverge towards the rear seat wall.

In any embodiment, at least a part of one or both of the first and second seat sidewalls of the toggle seat diverge at an angle θ of about 5° to 15° to a line X that is orthogonal to a rear seat wall of the toggle seat.

In any embodiment, the first and/or second seat sidewall of the toggle seat has an upper section (e.g. closer to the front seat wall) that is orthogonal to a rear seat wall and a lower section (e.g. closer to the rear seat wall) that diverges towards the rear seat wall.

In any embodiment, lower edges of the seat sidewalls are chamfered.

In another aspect, the toggle seat and retention plate are provided as a single plate. The plate is generally L-shaped and comprises a seat plate and a retention plate that are typically disposed in an orthogonal (or near orthogonal) disposition to each other. The plate is generally a monoblock plate. The seat plate generally comprises a rear seat wall, a front seat wall comprising an elongated plate-receiving groove, and a sidewall extending between the front and rear walls. Typically, at least a part of the sidewall diverges towards the rear seat wall. The retention seat of the swing jaw may have dimensions that correspond to the single plate, allowing the single plate to be attached to and detached from the retention seat. Thus the invention relates to a single plate comprising a toggle seat and retention plate, a swing jaw comprising a single plate of the invention and comprising a retention plate dimensioned to couple with and conform closely to the L-shaped single plate, or a jaw crusher comprising a swing jaw of the invention.

Other aspects and preferred embodiments of the invention are defined and described in the other claims set out below.

### BRIEF DESCRIPTION OF THE FIGURES

FIG. 1 is a perspective view from the rear of a lower end of swing jaw of a jaw crusher showing a toggle seat mounting assembly of the prior art.

FIG. 2 is a side elevational view of the toggle seat mounting assembly of the prior art illustrated in FIG. 1.

FIG. 3 is a perspective view from the front of swing jaw of a jaw crusher according to an embodiment of the invention.

FIG. 4 is a perspective view from the rear of swing jaw of a jaw crusher according to an embodiment of the invention.

FIG. 5 is a perspective view of a toggle seat according to an embodiment of the invention.

FIG. 6 is a side elevational view of a toggle seat according to an embodiment of the invention.

FIG. 7 is a perspective view of part of a swing jaw according to an embodiment of the invention showing the toggle seat wedged in situ by the retention seat.

FIG. 8 is a side elevational view of details of a swing jaw according to an embodiment of the invention illustrated in FIG. 7.

FIG. 9 is a perspective view of a rear of a detachable retention plate forming part of the swing jaw of the invention.

FIG. 10 is a perspective view of a front of a detachable retention plate forming part of the swing jaw of the invention.

FIG. 11 is a side elevational view of a toggle seat according to an embodiment of the invention.

FIG. 12 is a side elevational view of details of a swing jaw according to an embodiment of the invention.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

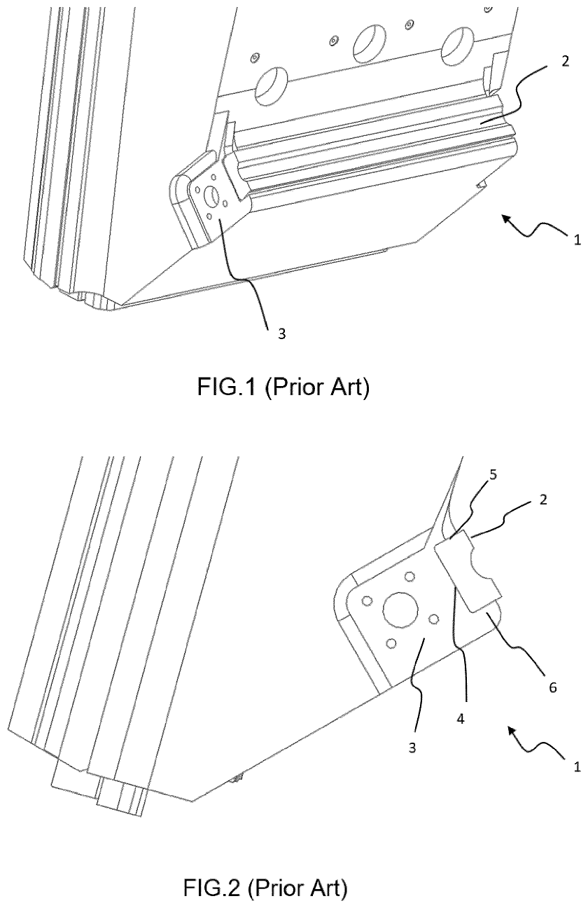

Referring initially to FIGS. 1 and 2, there is illustrated a lower part of swing jaw 1 of the prior art and illustrating a toggle seat 2 mounted on a retention seat 3 which forms part of the swing jaw casting. The retention seat 3 comprises an elongated recess defined by a rear wall 4 and sidewalls 5, 6 that are part of the casting, where the sidewall are orthogonal to the rear wall. The toggle seat has a profile that closely matches the profile of the retention seat such that the toggle seat friction fits into the retention seat, and in practice has to be hammered into position in its seat or loose fit and held through toggle plate clamping. While this arrangement maintains the toggle seat in position very securely, when the toggle seat wears and deforms due to the forces being transferred by the toggle plate, it is in practice impossible to remove without cutting it out or welding lifting fixtures on to the plate.

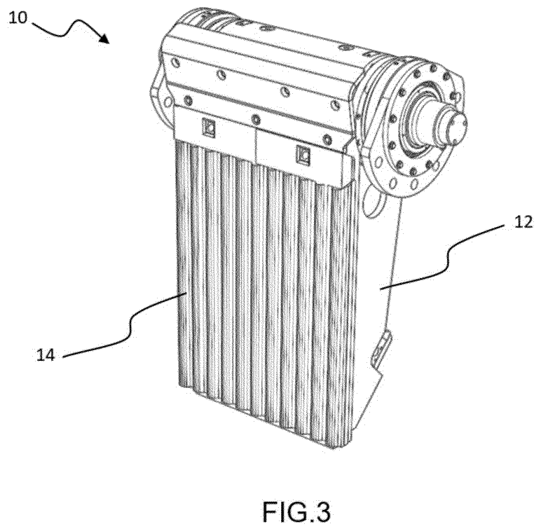

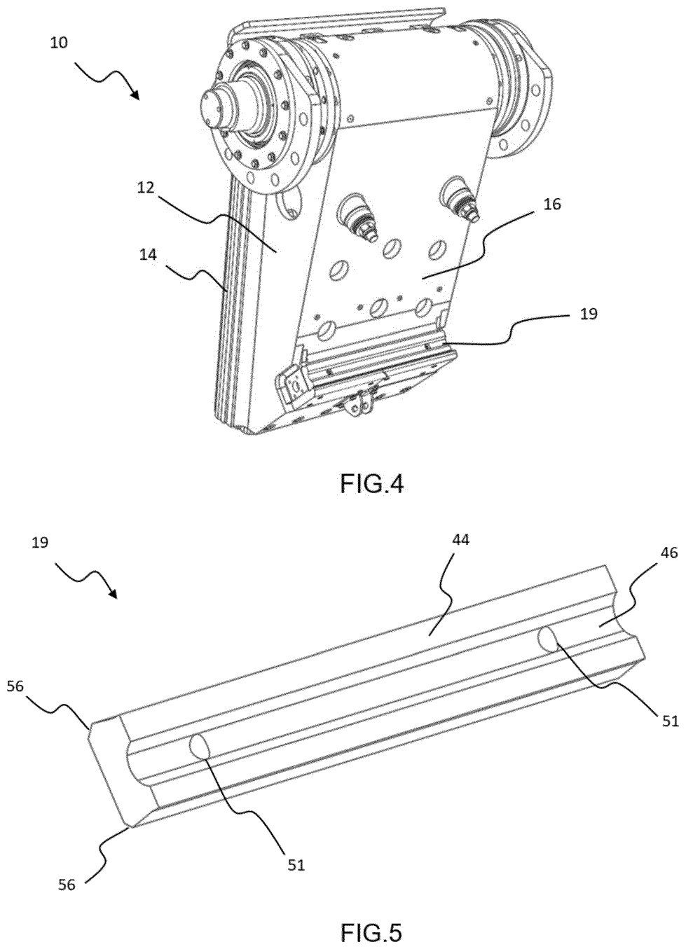

Referring now to FIGS. 3, 4, 7 and 8, a swing jaw of the invention, indicated generally by the reference numeral 10, and in which parts described with reference to the previous embodiments are assigned the same reference numerals, is described. The swing jaw 10 (only a low part is shown and described) comprises a cast frame 12 with a front face to which a fluted jaw liner 14 is mounted and a rear face 16 comprising a retention seat and a toggle seat 19 clamped in the retention seat. Unlike the retention seat of the prior art in which the elongated recess for the toggle seat has a rear wall and opposed sidewalls, the retention seat of the invention comprises a fixed cast part 20 comprising a rear wall 22, an inwardly tapering sidewall 24, and two detachable retention plates 26 that are bolted to the fixed cast part 20 to clamp the toggle seat 19 between the detachable retention plates 26 and the cast sidewall 24.

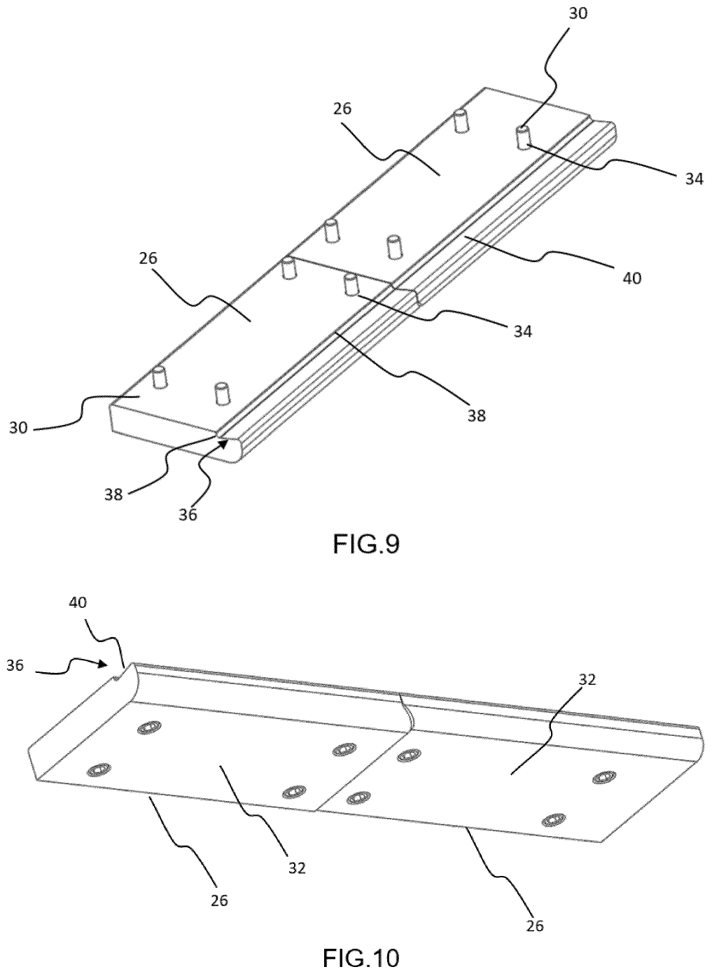

The detachable retention plates 26 are illustrated in more detail in FIGS. 9 and 10. Each comprises a mounting face 30 and an opposed front face 32. Holes are provided to receive mounting bolts 34 for the purpose of mounting the plate to a lower surface 34a of the fixed cast part 20. An outer edge of the mounting face 30 of the plate 26 includes an elongated recess 36 defined by an inward step 38 and a sloping sidewall 40 that tapers outwardly. The recess is dimensioned to engage with a side of the toggle seat.

In more detail, and referring to FIGS. 5, 6 and 8, the toggle seat 19 comprises an elongated body having a rear seat wall 42, a front seat wall 44 comprising an elongated plate-receiving groove 46, a first seat sidewall 48 and a second seat sidewall 50. Counterbore holes 51 are provided in the groove 46 for the purpose of bolting the toggle seat 19 to the rear wall 22 of the fixed cast part 20. The seat sidewalls 48, 50 have an upper section 54 that is orthogonal to the rear seat wall 42, a lower chamfered section 56, and an intermediate wall section 58 that tapers outwardly towards the rear seat wall 42 at an angle of about 10° to a line X that is orthogonal to the rear seat wall 42. When the retention plate 26 is bolted to the lower surface 34a of the fixed cast part 20, the tapered intermediate wall section 58 of the second seat sidewall 50 abuts against the sidewall 40 of the elongated recess 36, with the result that the toggle seat 19 is wedged and clamped between the retention plates 26 and the inwardly tapering sidewall 24 of the fixed cast part 20.

In use, a toggle seat 19 is bolted on the cast part 20 of the retention seat with the rear wall 42 on the toggle seat 19 abutting the rear wall 22 of the cast part of the retention seat. The retention plates 26 are then bolted to the lower surface 34a of the fixed cast part 20 with the elongated recess 36 receiving the seat sidewall 58 of the toggle seat 19. Once the retention plate is bolted in position, the toggle seat is held in a wedged clamping position between the seat sidewall 24 and the sidewall 40 of the elongated recess 36. During use, as the toggle seat encounters wear and deforms, the toggle seat can be easily removed by unbolting the detachable retention plate thereby releasing the wedged clamping and unbolting and detaching the toggle seat.

In FIG. 10 a perspective view of a front of a detachable retention plate forming part of the swing jaw of the invention is shown. The retention seat in the instant embodiment comprises two detachable retention plates 26. In a preferred embodiment the retention seat comprises three such detachable retentions plates 26.

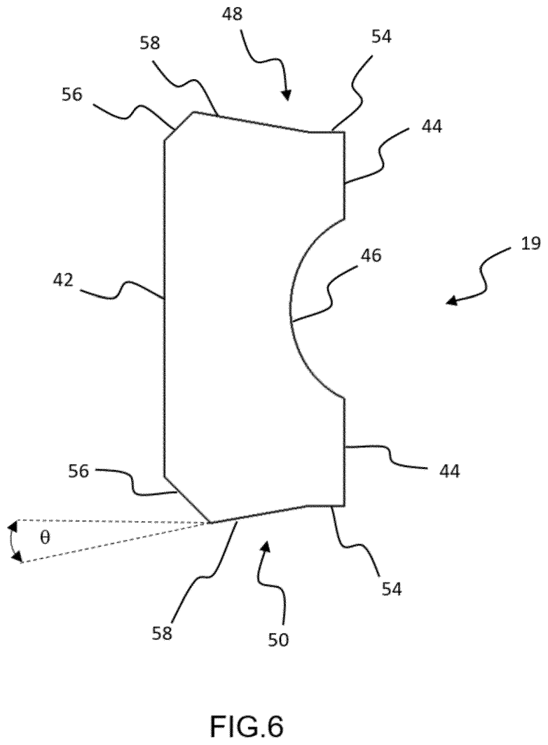

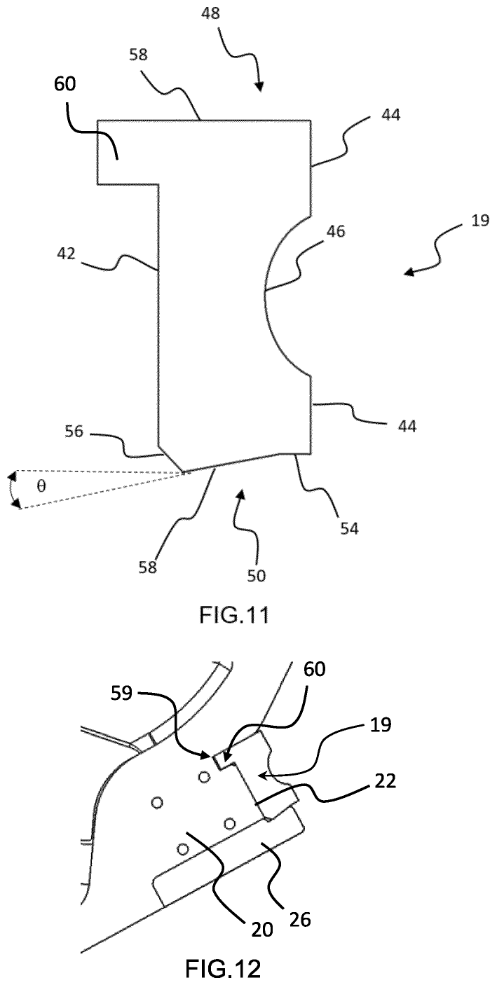

Referring to FIG. 11 there is show an embodiment of the toggle seat similar to the embodiment of FIG. 5 and FIG. 6 and may thus comprise any of the features of that embodiment. In the present embodiment, the toggle seat 19 also comprises a rear seat wall 42, a front seat wall 44 and comprises an elongated plate-receiving groove 46. An upper first seat sidewall 48 and a lower second seat sidewall 50, wherein the intermediate side wall 58 of the lower second seat sidewall 50 diverges towards the rear seat wall. In contrast, the upper first seat sidewall 48 is substantially perpendicular to the rear seat wall 42. Further to the instant embodiment, the toggle seat 19 comprises a support flange 60 protruding beyond the rear seat wall 42. The upper first seat wall 48 extends into the support flange 60 or vice versa, at least a portion of the upper first seat wall 48 is provided by the support flange 60.

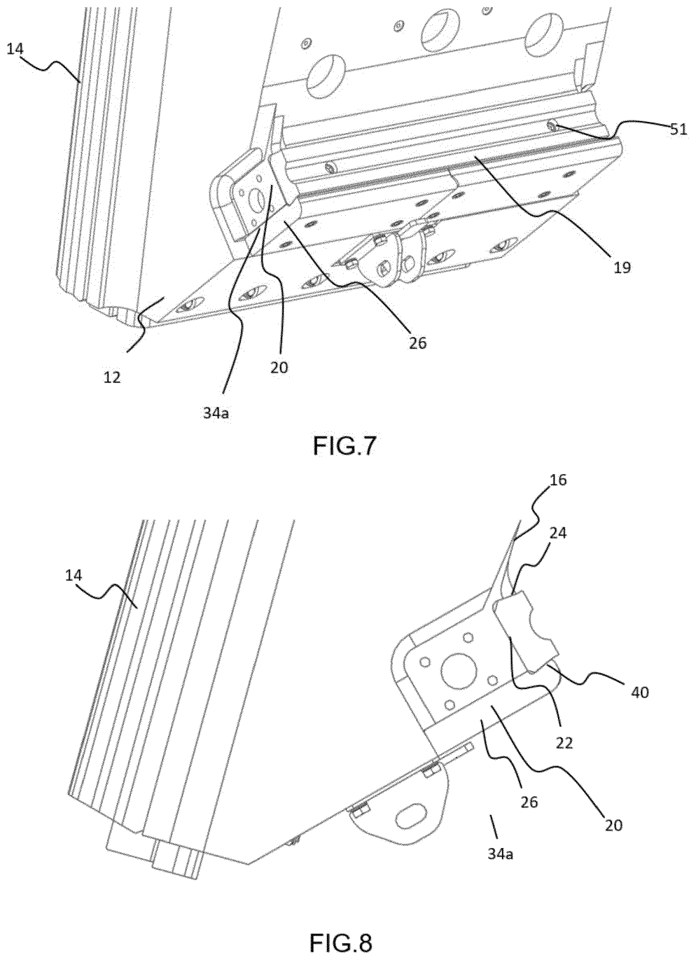

FIG. 12 shows an embodiment of the retention seat similar to that of FIG. 7 and FIG. 8 and may thus comprise any of the features of those embodiments. In the present embodiment, the retention seat upon assembly also comprises opposed sidewalls 24, 40, however only the lower side wall 40 of the opposed side walls 24, 40 diverges towards a rear wall 22 of the retention seat, to wedge the toggle seat 19 in position in the assembled retention seat.

Further to the instant embodiment, the retention seat comprises a support recess 59 extending into the retention seat 20 beyond the rear wall 22. The support recess 59 being configured to receive the support flange 60 of the toggle seat 19 for supporting the toggle seat 19 in the suspended position. In particular, the support flange 60 is then wedged in the support recess 59 and/or at least partially bears on a lower surface of the support recess 59.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A swing jaw of a jaw crusher comprising:
a cast swing jaw frame; and
a retention seat for a toggle seat, the retention seat including a first retention seat part, wherein the retention seat includes a detachable retention plate configured to couple to the first retention seat part so as to clamp the toggle seat therebetween in a wedged clamping arrangement.

2. The swing jaw according to claim 1, wherein the first retention seat part is integrally cast with the cast swing jaw frame.

3. The swing jaw according to claim 1, wherein the retention seat upon assembly includes opposed sidewalls, wherein a lower side wall of the opposed side walls diverges towards a rear wall of the retention seat to wedge the toggle seat in position in the assembled retention seat.

4. The swing jaw according to claim 1, wherein the retention seat upon assembly includes opposed sidewalls that diverge towards a rear wall of the retention seat to wedge the toggle seat in position in the assembled retention seat.

5. The swing jaw according to claim 1, wherein the retention seat includes a rear wall and a support recess extending into the retention seat beyond the rear wall and configured to receive a support flange of the toggle seat for supporting the toggle seat in a suspended position.

6. The swing jaw according to claim 1, wherein the first retention seat part includes a first sidewall and a rear wall of the retention seat, and wherein the detachable retention plate includes a second sidewall of the retention seat.

7. The swing jaw according to claim 1, wherein the cast swing jaw frame includes a recess for the detachable retention plate, and wherein the detachable retention plate includes a first part dimensioned to be accommodated in the recess and a second part that extends proud of the recess and includes the second sidewall of the retention seat.

8. The swing jaw according to claim 1, wherein the toggle seat includes a rear seat wall, a front seat wall having an elongated plate-receiving groove, an upper first seat sidewall and a lower second seat sidewall, wherein the lower second seat sidewall diverge towards the rear seat wall.

9. The swing jaw according to claim 1, wherein the toggle seat includes a rear seat wall, a front seat wall having an elongated plate-receiving groove, a first seat sidewall and a second seat sidewall, wherein the first seat sidewall and second seat sidewall diverge towards the rear seat wall.

10. The swing jaw according to claim 1, wherein the retention plate is configured to be bolted to the cast swing jaw frame.

11. The swing jaw according to claim 1, wherein the retention seat includes two or more detachable retention plates.

12. A jaw crusher comprising:
a fixed jaw; and
a swing jaw according to claim 1.
